(19) United States
(12) Patent Application Publication
(10) Pub. No.: US 2026/0228928 A1
(43) Pub. Date: Aug. 6, 2026

(54) DECODING METHOD, ENCODING METHOD, AND DECODING DEVICE

(71) Applicant: Panasonic Intellectual Property Corporation of America, Torrance, CA (US)

(72) Inventors: Atsushi ITO, Osaka (JP); Toshiyasu Sugio, Osaka (JP); Noritaka Iguchi, Osaka (JP); Takahiro Nishi, Nara (JP)

(21) Appl. No.: 19/631,188

(22) Filed: Mar. 27, 2026

Related U.S. Application Data
(63) Continuation of application No. PCT/JP2024/031103, filed on Aug. 30, 2024.
(60) Provisional application No. 63/542,351, filed on Oct. 4, 2023.

(51) Int. Cl. G06T 9/40; G06T 7/73

(52) U.S. Cl. CPC G06T 9/40; G06T 7/73; G06T 2200/04

(57) ABSTRACT

A decoding method is a decoding method of decoding three-dimensional points, and includes: calculating a position of a first point on an edge connecting two Triangle-Soup (TriSoup) vertices of a first TriSoup triangle using the two TriSoup vertices; shifting the position of the first point in a first direction; and generating a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

### CROSS REFERENCE TO RELATED APPLICATIONS

This is a continuation application of PCT International Application No. PCT/JP2024/031103 filed on August 30, 2024, designating the United States of America, which is based on and claims priority of U.S. Provisional Patent Application No. 63/542351 filed on October 4, 2023. The entire disclosures of the above-identified applications, including the specifications, drawings and claims are incorporated herein by reference in their entirety.

### FIELD

The present disclosure relates to a decoding method, an encoding method, a decoding device, and an encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### Citation List

### Patent Literature

International Publication WO 2014/020663

### SUMMARY

### Technical Problem

In such encoding and decoding of three-dimensional data, there is a demand for improving the accuracy of three-dimensional data that is reconstructed.

The present disclosure provides a decoding method, an encoding method, a decoding device, or an encoding device capable of improving the accuracy of three-dimensional data that is reconstructed.

### Solution to Problem

A decoding method according to one aspect of the present disclosure is a decoding method of decoding three-dimensional points. The decoding method includes: calculating a position of a first point on an edge connecting two Triangle-Soup (TriSoup) vertices of a first TriSoup triangle using the two TriSoup vertices; shifting the position of the first point in a first direction; and generating a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

An encoding method according to one aspect of the present disclosure is an encoding method of encoding three-dimensional points. The encoding method includes: calculating a position of a first point on an edge connecting two TriSoup vertices of a first TriSoup triangle using the two TriSoup vertices; shifting the position of the first point in a first direction; and generating a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

### Advantageous Effects

The present disclosure can provide a decoding method, an encoding method, a decoding device, or an encoding device capable of improving the accuracy of three-dimensional data that is reconstructed.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of an original point cloud according to an embodiment.

FIG. 2 is a diagram illustrating an example of a trimmed octree according to the embodiment.

FIG. 3 is a diagram illustrating an example in which a leaf-node according to the embodiment is two-dimensionally displayed.

FIG. 4 is a diagram for describing a method for generating a centroid vertex according to the embodiment.

FIG. 5 is a diagram for describing the method for generating a centroid vertex according to the embodiment.

FIG. 6 is a diagram illustrating an example of vertex information according to the embodiment.

FIG. 7 is a diagram illustrating an example of a TriSoup surface according to the embodiment.

FIG. 8 is a diagram for describing point cloud reconstruction processing according to the embodiment.

FIG. 9 is a diagram illustrating an example of a point cloud according to the embodiment.

FIG. 10 is a diagram illustrating an example of centroid vertex generation according to the embodiment.

FIG. 11 is a diagram illustrating an example of triangle (TriSoup surface) generation according to the embodiment.

FIG. 12 is a diagram illustrating an example of face vertex generation according to the embodiment.

FIG. 13 is a diagram illustrating an example of various vertices and an example of triangles according to the embodiment.

FIG. 14 is a diagram illustrating an example of interpolated vertices according to the embodiment.

FIG. 15 is a diagram illustrating the example of the interpolated vertices according to the embodiment.

FIG. 16 is a flowchart of a decoding process according to the embodiment.

FIG. 17 is a flowchart of a generation process for triangles and points according to the embodiment.

FIG. 18 is a flowchart of an encoding process according to the embodiment.

FIG. 19 is a diagram illustrating a syntax example of GDUH and GDU.

FIG. 20 is a diagram illustrating another syntax example of GDUH and GDU.

FIG. 21 is a diagram illustrating an example of various vertices and an example of triangles according to the embodiment.

FIG. 22 is a diagram illustrating an example of various vertices and an example of triangles when an adjustment process is performed, according to the embodiment.

FIG. 23 is a flowchart of a decoding process according to the embodiment.

FIG. 24 is a block diagram of a decoding device according to the embodiment.

FIG. 25 is a flowchart of an encoding process according to the embodiment.

FIG. 26 is a block diagram of an encoding device according to the embodiment.

### DESCRIPTION OF EMBODIMENTS

A decoding method according to one aspect of the present disclosure is a decoding method of decoding three-dimensional points. The decoding method includes: calculating a position of a first point on an edge connecting two Triangle-Soup (TriSoup) vertices of a first TriSoup triangle using the two TriSoup vertices; shifting the position of the first point in a first direction; and generating a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

With this, the decoding method generates the first point on the edge of the first TriSoup triangle in addition to the TriSoup vertices, and generates the second TriSoup triangle using the first point. Accordingly, it is possible to improve the accuracy of the reconstructed three-dimensional data. Furthermore, the decoding method may be able to further improve the accuracy of the three-dimensional data by shifting the position of the first point. Here, the accuracy is an index indicating how much the shape of the original point cloud has been reconstructed, and a higher value indicates better reconstruction of the original point cloud. In other words, a finer representation can be achieved by generating the second TriSoup triangle using the added first point as described in the decoding method, thus improving the accuracy.

For example, the first direction may be a direction in which the position of the first point moves away from a center of gravity of a plurality of edge vertices of the node. With this, the decoding method can accurately reconstruct the shape of the original point cloud that is convex in the direction away from the center of gravity of the plurality of edge vertices.

For example, the first direction may be a direction from a center of gravity of a plurality of edge vertices of the node toward a centroid vertex of the node. With this, the decoding method can improve the reconstruction accuracy around the centroid vertex.

For example, the first direction may be the direction in which the position of the first point moves away from the center of gravity of the plurality of edge vertices of the node, and be also a direction along a normal of the first TriSoup triangle. With this, the decoding method can reconstruct three-dimensional data to be closer to the shape of the original three-dimensional data.

For example, a shift amount applied in the shifting of the position of the first point may become greater as a distance between the center of gravity of the plurality of edge vertices and the centroid vertex of the node becomes greater. With this, the decoding method can reconstruct three-dimensional data to be closer to the shape of the original three-dimensional data.

For example, a shift amount applied in the shifting of the position of the first point may be calculated by multiplying a distance between the center of gravity of the plurality of edge vertices and the centroid vertex of the node by a coefficient, and the coefficient may be greater than 0 and less than 1/8. When the coefficient is too large, an error in which the corrected position is outside the node is prone to occur. In this regard, by using a coefficient less than 1/8, it is possible to reduce the occurrence of such an error.

For example, when a size of the node is greater than a threshold, the calculating of the position of the first point, the shifting of the position of the first point, and the generating of the second TriSoup triangle may be performed, and when the size of the node is less than the threshold, the calculating of the position of the first point, the shifting of the position of the first point, and the generating of the second TriSoup triangle may not be performed. When the size of the node is large, the accuracy of the reconstructed three-dimensional data is likely to be low. In such a case, by calculating the position of the first point, shifting the position of the first point, and generating the second TriSoup triangle, it is possible to efficiently improve the accuracy of the three-dimensional data.

For example, the first point may be a middle point of the edge. With this, the decoding method can efficiently improve the accuracy of the three-dimensional data by generating the first point at the position of the middle point of the edge.

For example, the two TriSoup vertices may include a face vertex generated on a face of the node excluding edges of the node. With this, the decoding method can improve the accuracy of the reconstructed three-dimensional data by using the face vertex.

For example, each of three TriSoup vertices of the first TriSoup triangle is any one of an edge vertex, a centroid vertex, and a face vertex provided on a face of the node excluding edges of the node, when a pair of the two TriSoup vertices is not a pair of the face vertex and the centroid vertex, the shifting of the position of the first point may be performed, and when the pair of the two TriSoup vertices is the pair of the face vertex and the centroid vertex, the shifting of the position of the first point may not be performed.

When the pair of the two TriSoup vertices is composed of the face vertex and the centroid vertex, the shape of the reconstructed three-dimensional data may deviate from the shape of the original three-dimensional data by shifting the position of the first point. Accordingly, in such a case, by not shifting, it is possible to improve the accuracy of the reconstructed three-dimensional data.

An encoding method according to one aspect of the present disclosure is an encoding method of encoding three-dimensional points. The encoding method includes: calculating a position of a first point on an edge connecting two TriSoup vertices of a first TriSoup triangle using the two TriSoup vertices; shifting the position of the first point in a first direction; and generating a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

With this, the encoding method generates the first point on the edge of the first TriSoup triangle in addition to the TriSoup vertices, and generates the second TriSoup triangle using the first point. Accordingly, it is possible to improve the accuracy of the reconstructed three-dimensional data. Furthermore, the encoding method may be able to further improve the accuracy of the three-dimensional data by shifting the position of the first point.

A decoding device according to one aspect of the present disclosure is a decoding device that decodes three-dimensional points and includes a processor and memory. Using the memory, the processor: calculates a position of a first point on an edge connecting two TriSoup vertices of a first TriSoup triangle using the two TriSoup vertices; shifts the position of the first point in a first direction; and generates a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

An encoding device according to one aspect of the present disclosure is an encoding device that encodes three-dimensional points and includes a processor and memory. Using the memory, the processor: calculates a position of a first point on an edge connecting two TriSoup vertices of a first TriSoup triangle using the two TriSoup vertices; shifts the position of the first point in a first direction; and generates a second TriSoup triangle using the first point having the position shifted, in which the first TriSoup triangle is used to generate a plurality of three-dimensional points in a node according to a TriSoup scheme, and the node is a unit in an octree structure including the plurality of three-dimensional points.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment

Hereinafter, an encoding device (three-dimensional data encoding device) and a decoding device (three-dimensional data decoding device) according to the present embodiment will be described. The encoding device encodes three-dimensional data to thereby generate a bitstream. The decoding device decodes the bitstream to thereby generate three-dimensional data.

Three-dimensional data is, for example, three-dimensional point cloud data (also called point cloud data). A point cloud, which is a set of three-dimensional points, represents the three-dimensional shape of an object. The point cloud data includes position information and attribute information on the three-dimensional points. The position information indicates the three-dimensional position of each three-dimensional point. It should be noted that position information may also be called geometry information. For example, the position information is represented using an orthogonal coordinate system or a polar coordinate system.

Attribute information indicates color information, reflectance, transmittance, infrared information, a normal vector, or time-of-day information, for example. One three-dimensional point may have a single item of attribute information or have a plurality of kinds of attribute information.

It should be noted that although mainly the encoding and decoding of position information will be described below, the encoding device may perform encoding and decoding of attribute information.

### TriSoup scheme

The encoding device according to the present embodiment encodes position information by using a Triangle-Soup (TriSoup) scheme.

The TriSoup scheme is an irreversible compression scheme for encoding position information on point cloud data. In the TriSoup scheme, an original point cloud being processed is replaced by a set of triangles, and the point cloud is approximated on the planes of the triangles. Specifically, the original point cloud is replaced by vertex information on vertexes (hereinafter also referred to as vertices) within each node, and the vertexes are connected with each other to form a group of triangles. Furthermore, the vertex information for generating the triangles is stored in a bitstream, which is sent to the decoding device.

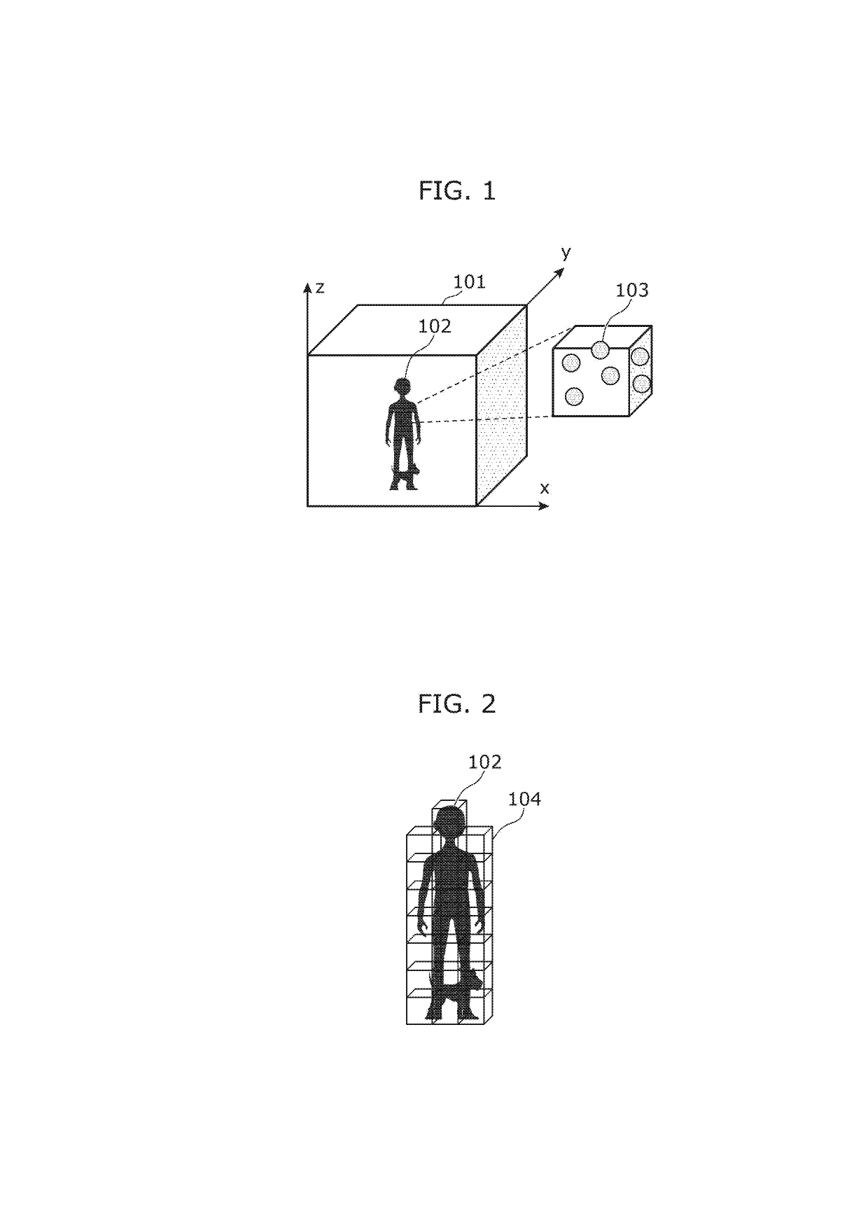

Now, encoding processing using the TriSoup scheme will be described. FIG. 1 is a diagram illustrating an example of an original point cloud. As shown in FIG. 1, point cloud 102 of an object is in target space 101 and includes points 103.

First, the encoding device divides the original point cloud into an octree up to a predetermined depth. In octree division, a target space is divided into eight nodes (subspaces), and 8-bit information (an occupancy code) indicating whether each node includes a point cloud is generated. A node that includes a point cloud is further divided into eight nodes, and 8-bit information indicating whether these eight nodes each include a point cloud is generated. This processing is repeated up to a predetermined layer.

Here, typical octree encoding divides nodes until the number of point clouds in each node reaches, for example, one or a threshold. In contrast, the TriSoup scheme performs octree division up to a layer along the way and not for layers lower than that layer. Such an octree up to a midway layer is called a trimmed octree.

FIG. 2 is a diagram illustrating an example of a trimmed octree. As shown in FIG. 2, point cloud 102 is divided into leaf-nodes 104 (lowest-layer nodes) of a trimmed octree.

The encoding device then performs the following processing for each leaf-node 104 of the trimmed octree. It should be noted that a leaf-node may hereinafter also be simply referred to as a node. The encoding device generates vertexes on edges of the node as representative points of the point cloud near the edges. These vertexes are called edge vertexes. For example, an edge vertex is generated on each of a plurality of edges (for example, four parallel edges).

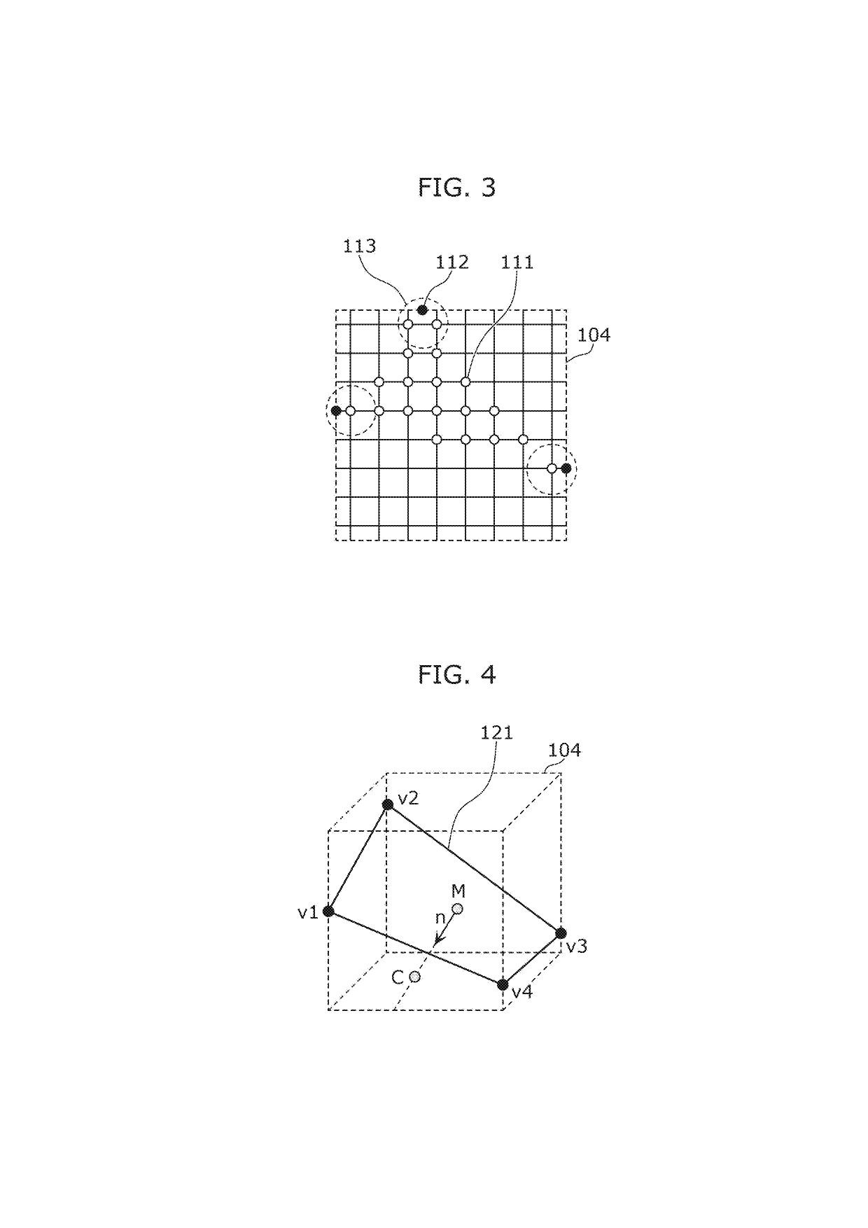

FIG. 3 is a diagram illustrating an example of two-dimensional display of leaf-node 104, for example, the xy-plane viewed along the z-direction shown in FIG. 1. As shown in FIG. 3, edge vertexes 112 are generated on edges based on points near the edges, among points 111 within leaf-node 104.

It should be noted that the dotted lines in FIG. 3 along the perimeter of leaf-node 104 represent the edges. Also in this example, each edge vertex 112 is generated at a weighted average of the positions of points within the distance 1 from the corresponding edge (points within each range 113 in FIG. 3). It should be noted that the unit of distance may be, by way of example and not limitation, the resolution of the point cloud. Although the distance (the threshold) is 1 in this example, the distance may be a value other than 1 or may be variable.

The encoding device then generates a vertex inside the node as well, based on a point cloud located in the direction of the normal to the plane that includes edge vertexes. This vertex is called a centroid vertex.

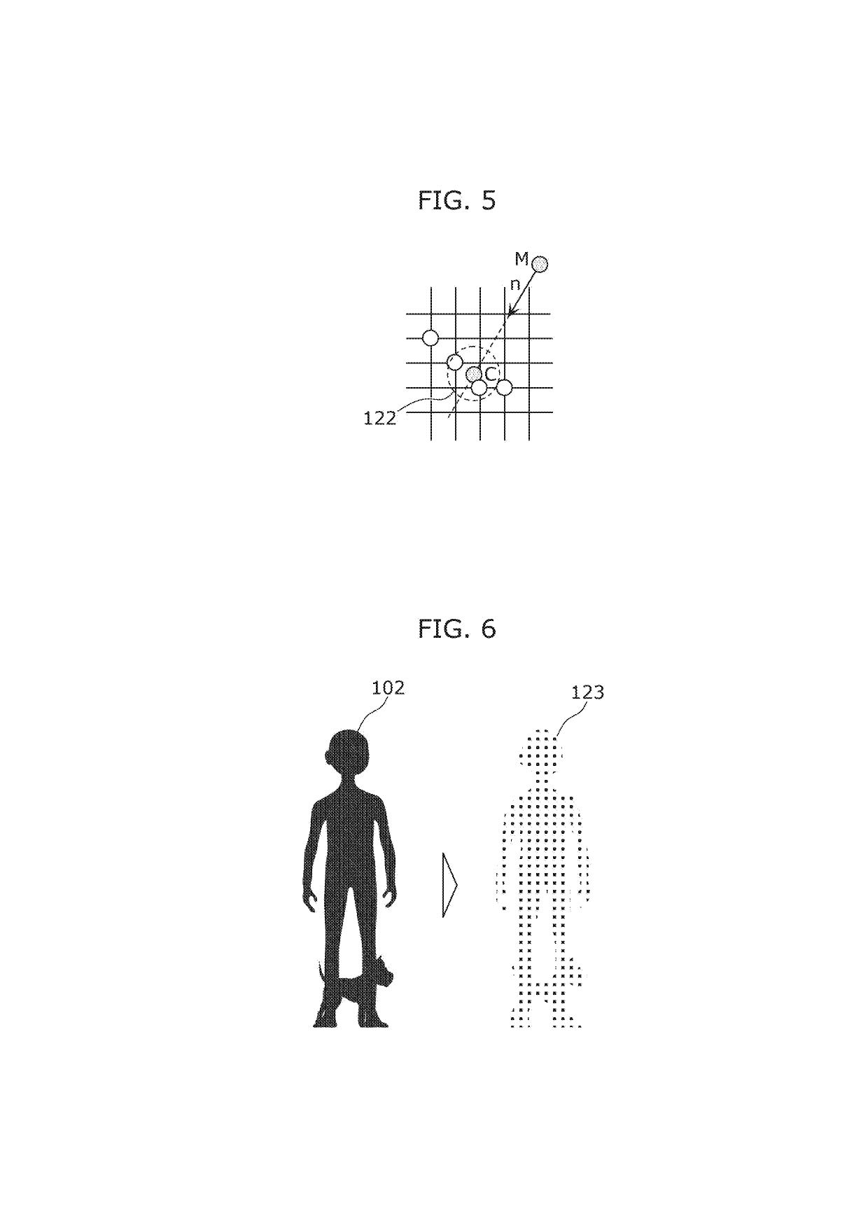

FIGS. 4 and 5 are diagrams for describing a method for generating the centroid vertex. First, the encoding device selects, for example, four points as representative points from a group of edge vertexes. In the example shown in FIG. 4, edge vertexes v1 to v4 are selected. The encoding device then calculates approximate plane 121 passing through the four points. The encoding device then calculates normal n to approximate plane 121 and average coordinates M of the four points. The encoding device then generates centroid vertex C at weighted-average coordinates of one or more points near a half line extending along normal n from average coordinates M (e.g., points within range 122 shown in FIG. 5).

The encoding device then entropy-encodes vertex information, which is information on the edge vertexes and the centroid vertex, and stores the encoded vertex information in a geometry data unit (hereinafter referred to as a GDU) included in the bitstream. It should be noted that, in addition to the vertex information, the GDU includes information indicating the trimmed octree.

FIG. 6 is a diagram illustrating an example of the vertex information. The above processing transforms point cloud 102 into vertex information 123, as shown in FIG. 6.

Now, decoding processing for the bitstream generated as above will be described. First, the decoding device decodes the GDU from the bitstream to obtain the vertex information. The decoding device then connects the vertexes to generate a TriSoup surface, which is a group of triangles.

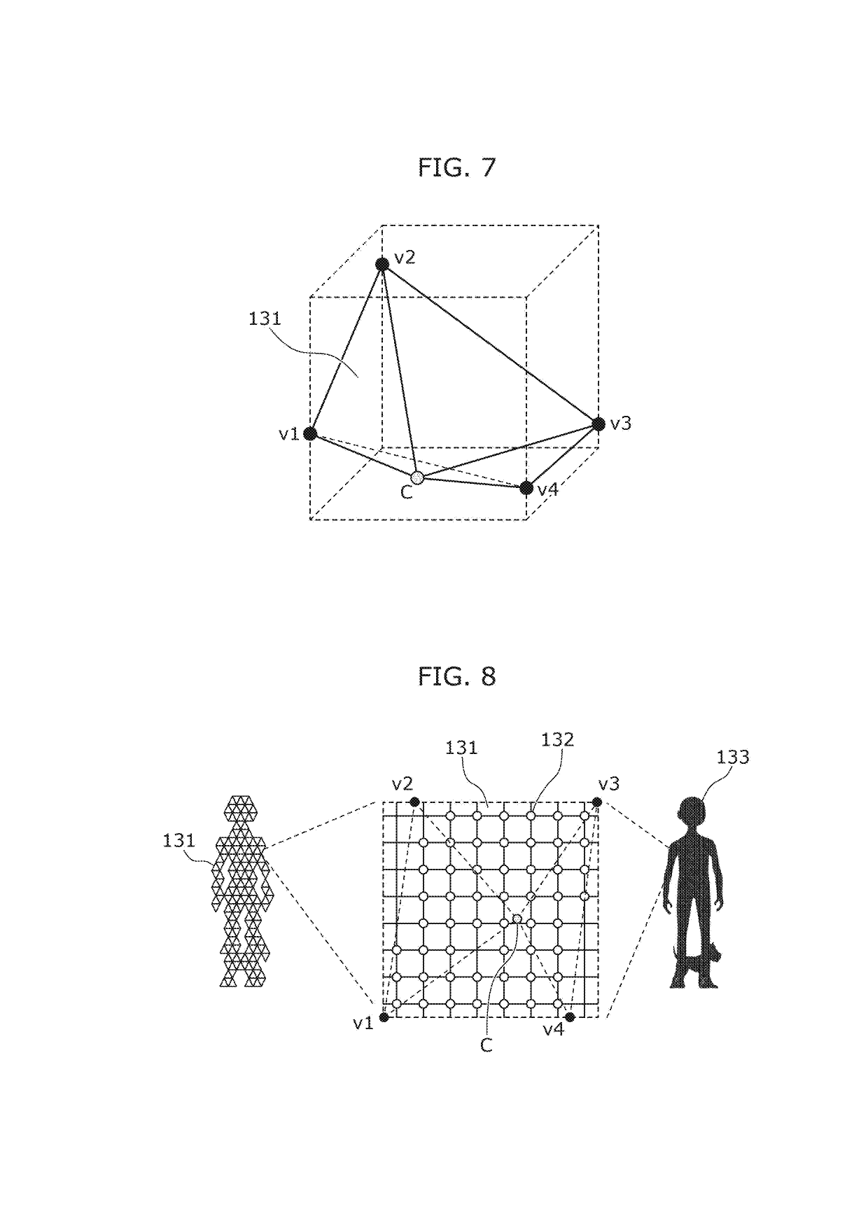

FIG. 7 is a diagram illustrating an example of the TriSoup surface. In the example shown in FIG. 7, four edge vertexes v1 to v4 and centroid vertex C are generated based on the vertex information. Furthermore, triangles 131 (a TriSoup surface) are generated, each having centroid vertex C and two edge vertexes as its vertexes. For example, a pair of two edge vertexes on a pair of two adjacent edges is selected to form triangle 131 having the selected pair of edge vertexes and the centroid vertex as its vertexes.

FIG. 8 is a diagram for describing point cloud reconstruction processing. The above processing is performed for each leaf-node to generate a three-dimensional model that represents the object with triangles 131, as shown in FIG. 8.

The decoding device then generates points 132 at regular intervals on the surface of triangles 131 to reconstruct the position information on point cloud 133.

### Example of representation of ridge line of point cloud surface

According to the TriSoup scheme, the shape of the ridge line (ridge) across the neighboring nodes cannot be reconstructed in some cases. In contrast, the encoding device generates the face vertex on the surface in contact with the neighboring node, and reconstructs the point cloud also on the surface of the triangle generated based on the centroid vertex, the face vertices, and the edge vertices.

For example, in a case where a bent portion of the point cloud distribution (point cloud surface) is distributed within the leaf node, the surface model made by connecting the vertices cannot reproduce the shape of the original point cloud in some cases because the corner of the point cloud surface and the edge do not intersect each other and no vertex is formed at the position of the corner.

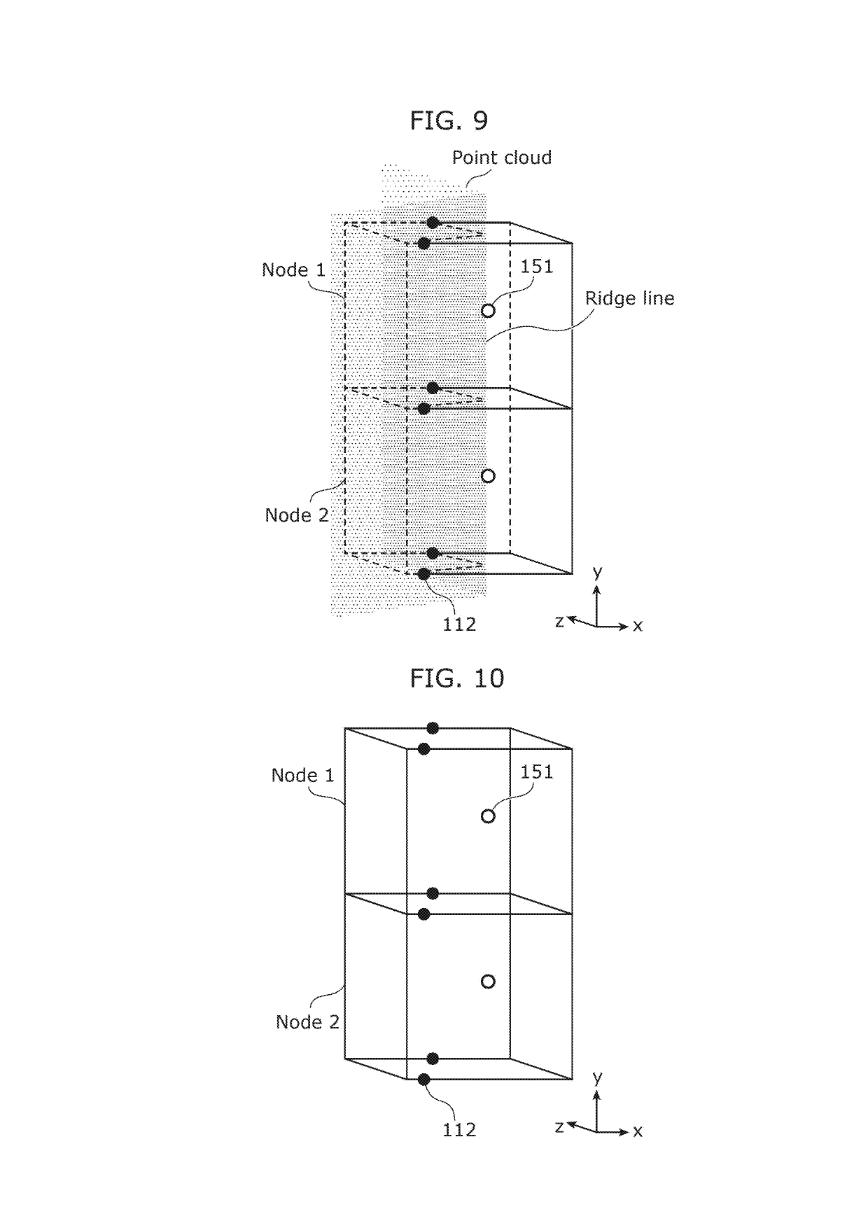

FIG. 9 is a diagram illustrating an example of a point cloud in a case where a point cloud is distributed across node 1 and node 2, and a ridge line is formed. As shown in FIG. 9, based on the point cloud distribution close to edges, edge vertices 112 are generated.

FIG. 10 is a diagram illustrating a centroid vertex generation example in this case. As shown in FIG. 10, each centroid vertex 151 is formed in the normal direction of an approximate plane of the edge vertex group.

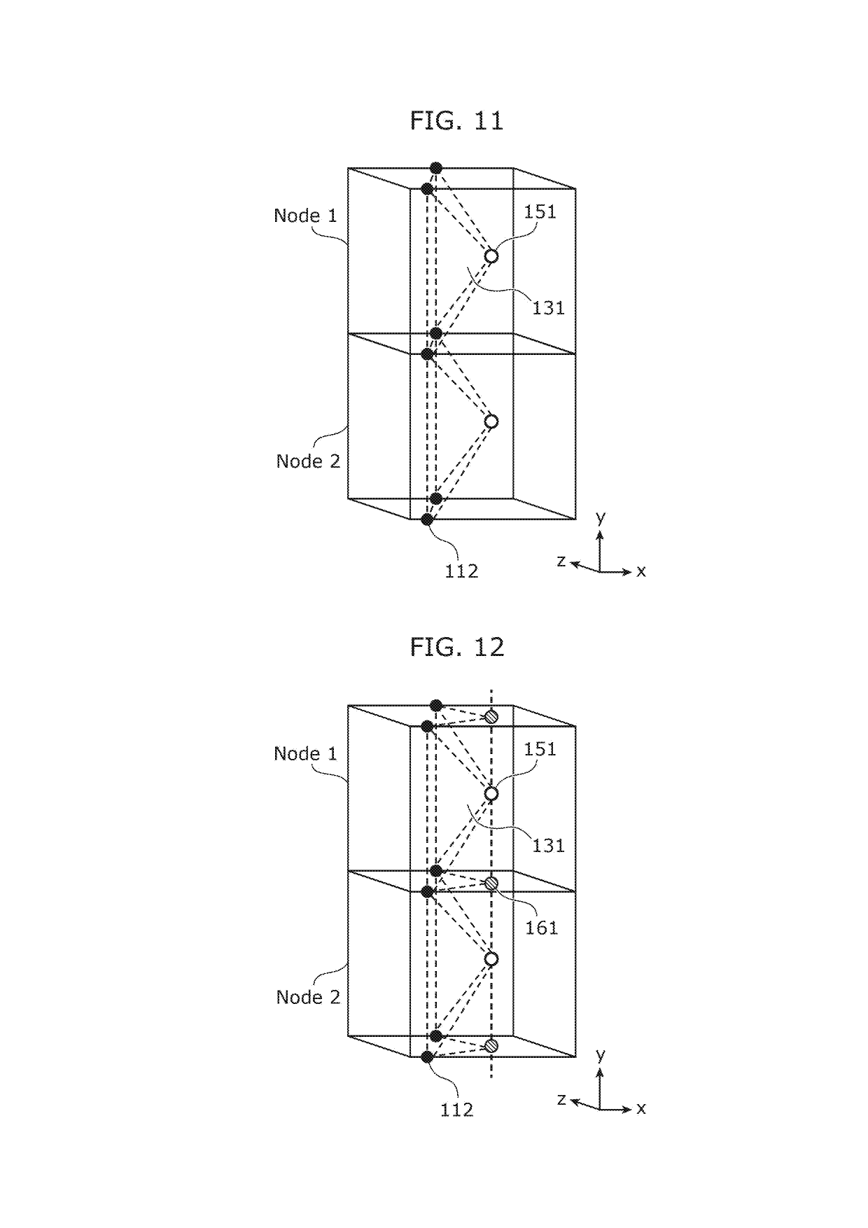

FIG. 11 is a diagram illustrating a generation example of triangles 131 (TriSoup surface) in this case. As shown in FIG. 11, each triangle 131 is generated by connecting a plurality of vertices (plurality of edge vertices and a centroid vertex). In this case, as illustrated in FIG. 11, the point cloud in the vicinity of the node boundary cannot be reproduced.

This is because the centroid vertex successfully samples the original point cloud surface but the current scheme can create no vertex between two centroid vertices of two neighboring nodes. For example, in a case where a ridge line is continuously distributed in the node along the direction of any of x, y, and z axes, no vertex corresponding to the ridge line is formed because the ridge line is not across any edge. Accordingly, this problem occurs.

In the present embodiment, the encoding device predicts the ridge line of the point cloud surface. Upon determination that two neighboring nodes have the same ridge line, this device transfers, to the decoding device, information for connecting two centroid vertices of the two neighboring nodes by a line segment. This information is, for example, 1-bit information assigned to each surface between nodes.

The decoding device connects the centroid vertices using this information, and generates a new vertex (face vertex) at an intersection between the obtained line segment and a shared surface between the nodes. When generating triangle 131, the decoding device can reproduce the ridge line using the new vertex.

Since the coordinate position of the face vertex is not quantized, a problem of positional deviation due to quantization is not present.

FIG. 12 is a diagram illustrating a face vertex generation example. As shown in FIG. 12, the decoding device can reproduce the ridge line by generating face vertex 161 and generating triangle 131 using face vertex 161.

According to the method described above, the point cloud surface in the vicinity of the node boundary can be reproduced. Accordingly, a decoded point cloud more similar to the original point cloud can be obtained. It should be noted that in the above description, the point cloud surface is only used to describe the problem concerning the ridge line. The ridge line is not required to be actually obtained.

### Interpolated vertex process

In the TriSoup scheme, in addition to the centroid vertex, two TriSoup vertices (the edge vertex or the face vertex) are sequentially selected in the node, and a triangle (also referred to as a TriSoup triangle or a TriSoup surface) is sequentially generated from these three vertices. Moreover, the point cloud is reconstructed by generating a plurality of points on the surface of each triangle.

However, there is a problem of deterioration in quality of the reconstructed point cloud under low-bitrate conditions (i.e., when the size of the node is large). In particular, when the original point cloud has a curved shape and the size of the node is increased, the area of each triangle in the node increases. Accordingly, the curved surface of the original point cloud cannot be represented, and thus an angular point cloud is reconstructed.

It should be noted that, hereinafter, point cloud reconstruction will be described mainly in the decoding device, but the similar process may be performed also in the encoding device.

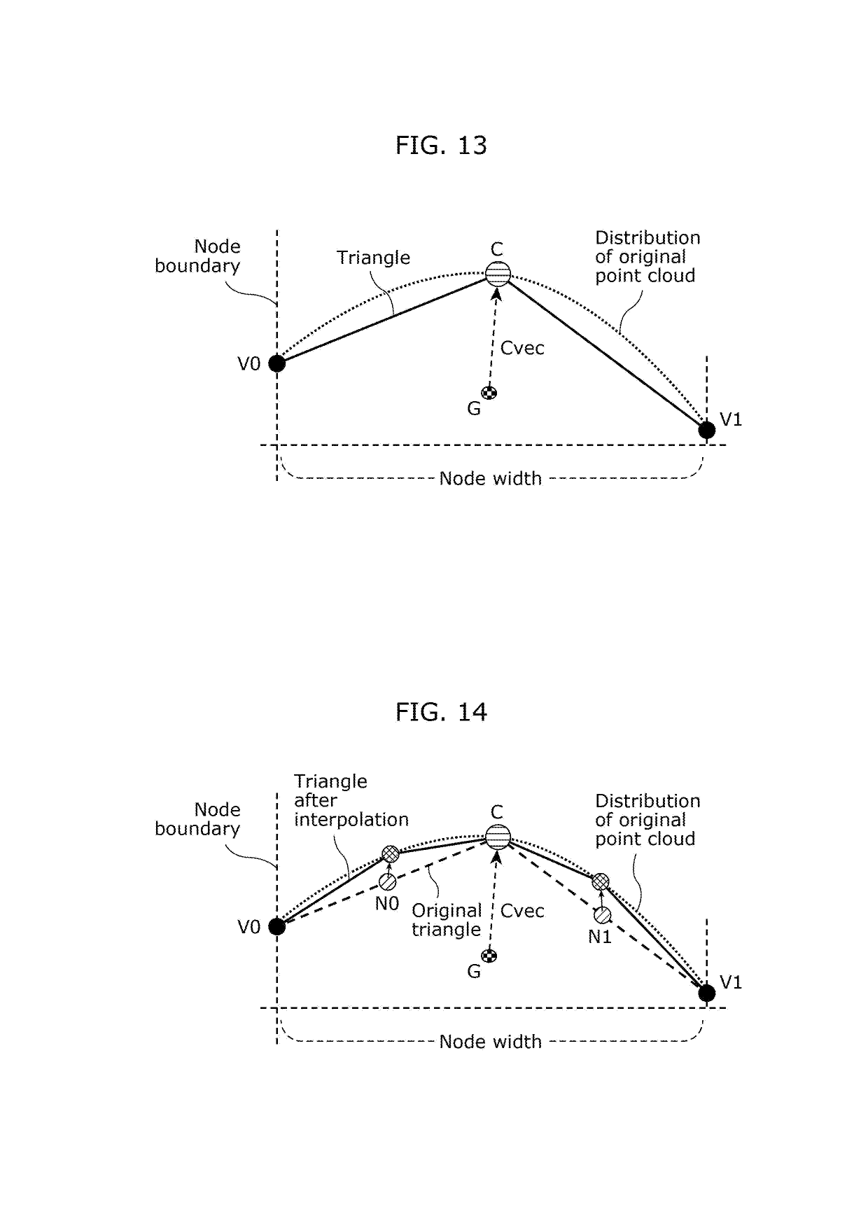

FIG. 13 is a diagram illustrating an example of various vertices and an example of triangles. This diagram illustrates the triangles as viewed from the side. TriSoup vertices V0 and V1 are each the edge vertex or the face vertex formed on the node boundary (a node edge or a node face). A triangle is generated from centroid vertex C, TriSoup vertex V0, and another TriSoup vertex (not illustrated), and another triangle is generated from centroid vertex C, TriSoup vertex V1, and another TriSoup vertex (not illustrated).

In the present embodiment, the decoding device subdivides each triangle using an interpolated vertex at the stage of point cloud reconstruction. FIG. 14 is a diagram illustrating an example of interpolated vertices to be generated. For example, the decoding device generates an interpolated vertex at the middle point of an edge of each triangle. In the example illustrated in FIG. 14, the decoding device generates interpolated vertex N0 at the middle point between centroid vertex C and TriSoup vertex V0, and interpolated vertex N1 at the middle point between centroid vertex C and TriSoup vertex V1.

Next, the decoding device adjusts (shifts) the positions of interpolated vertices N0 and N1. For example, the decoding device shifts the positions (coordinates) of interpolated vertices N0 and N1 in the direction from center of gravity G of an edge vertex group toward centroid vertex C (in the direction of vector Cvec). In this manner, the decoding device can improve the accuracy of the reconstructed point cloud, and can generate the reconstructed point cloud that is close to the curved shape of the original point cloud and is subjectively superior.

The decoding device determines whether to perform a generation process for the interpolated vertex and an adjustment process for the interpolated vertex (hereinafter, a process including the generation process for the interpolated vertex and the adjustment process for the interpolated vertex is also referred to as an interpolated vertex process) based on an interpolated-vertex enable flag stored in a geometry data unit header (GDUH). GDUH is the header information of GDU, and GDU is a data unit for storing the position information (geometry information) of the point cloud. For example, GDU includes information of nodes.

Moreover, the decoding device sets the shift amount (adjustment amount) of the interpolated vertex to, for example, a value proportional to a distance from center of gravity G of the edge vertex group to centroid vertex C (the length of vector Cvec).

Moreover, when the original point cloud is a planar point cloud, the encoding device sets the interpolated-vertex enable flag to OFF (the interpolated vertex process is not performed). In this manner, the decoding device can maintain a process of reconstructing a planar portion as a plane.

Moreover, even when the interpolated-vertex enable flag is ON, in the case where the length of vector Cvec is 0, the decoding device does not perform the position adjustment of this interpolated vertex. In the case where the length of vector Cvec is 0, the shape of the original point cloud in the node is likely to be flat. Accordingly, the decoding device can improve the accuracy of the reconstructed point cloud.

It should be noted that, instead of the middle point interpolation, another method may be used as the interpolation method. For example, interpolated vertex N0 may be generated at any position on the edge connecting centroid vertex C and TriSoup vertex V0. For example, interpolated vertex N0 may be generated at a position where the ratio of the distance between interpolated vertex N0 and centroid vertex C to the distance between interpolated vertex N0 and TriSoup vertex V0 is predetermined.

Moreover, this interpolated vertex process may be repeated multiple times. In other words, the first triangle may be subdivided into second triangles through the interpolated vertex process, and at least one of the second triangles may be subdivided into third triangles through the interpolated vertex process.

As described above, the accuracy of the reconstructed point cloud can be improved by performing the interpolated vertex process. The accuracy of the reconstructed point cloud can be improved by decreasing the size of the node. However, by performing the interpolated vertex process, the increase in data amount included in the bitstream can be more reduced than the case where the size of the node is decreased. Moreover, the interpolated-vertex enable flag is additionally stored in the bitstream. However, for example, when the interpolated-vertex enable flag is stored on a GDU unit basis, by only adding 1-bit flag per GDU, the point cloud can be reconstructed to have a high-definition shape. In other words, by using the interpolated vertex process, it is possible to improve the accuracy of the reconstructed point cloud while reducing the increase in data amount of the bitstream.

### Adjustment process for interpolated vertex

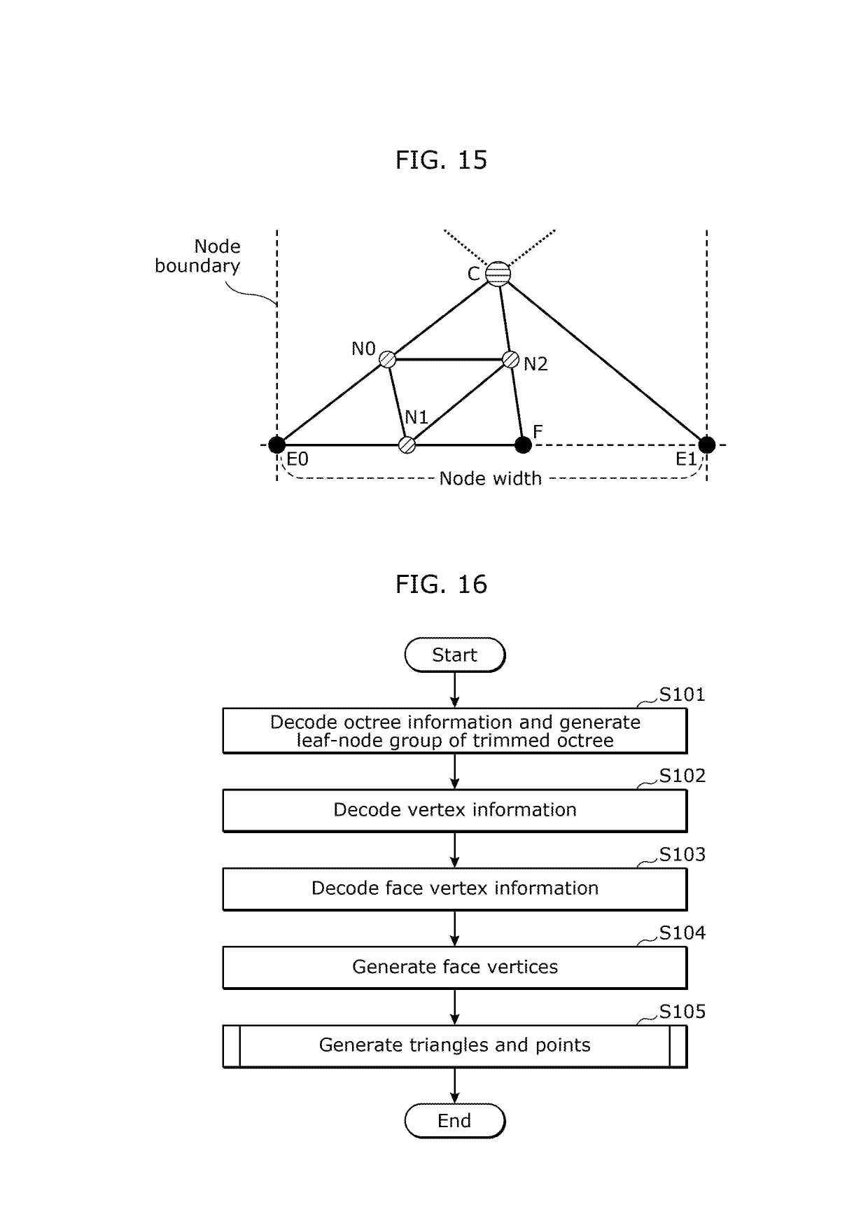

Hereinafter, an adjustment (shift) process for an interpolated vertex according to the type of vertex will be described. FIG. 15 is a diagram illustrating the example of the interpolated vertices. This diagram corresponds to, for example, the node illustrated in FIG. 13 and FIG. 14 as viewed from top to bottom. In other words, in FIG. 15, centroid vertex C protrudes toward the front, and center of gravity G of the edge vertex group is hidden on the far side of the diagram. Edge vertices and face vertices also exist on the upper side of the node, but illustration thereof is omitted. The positions of interpolated vertices N0 to N2 are corrected (shifted) toward the front.

In the example illustrated in FIG. 15, for first triangle C-E0-F having centroid vertex C, edge vertex E0, and face vertex F as its vertices, interpolated vertex N0 is generated on edge C-E0, interpolated vertex N1 is generated on edge E0-F, and interpolated vertex N2 is generated on edge F-C.

By subdividing first triangle C-E0-F using these interpolated vertices N0, N1, and N2, four new second triangles are generated. In other words, second triangle C-N0-N2, second triangle N0-E0-N1, second triangle N2-N1-F, and second triangle N0-N1-N2 are generated.

Here, the positions of interpolated vertices N0, N1, and N2 are adjusted according to the direction and length of vector Cvec. Accordingly, the shape represented by the four second triangles is a more rounded shape than the shape represented by first triangle C-E0-F.

Hereinafter, the adjustment process for each of interpolated vertices N0, N1, and N2 will be described. In the present embodiment, the process is switched according to a first condition of whether the interpolated vertex is located on a node boundary (whether the edge on which the interpolated vertex is generated coincides with the node boundary). The process is also switched according to a second condition of whether a pair of two vertices at both ends of the edge on which the interpolated vertex is generated is a pair of a centroid vertex and a face vertex.

First, adjustment process for interpolated vertex N0 will be described. Here, interpolated vertex N0 is a case that corresponds to neither the above first condition nor the second condition. In this case, the above-mentioned adjustment process for the interpolated vertex is performed.

Here, the shift amount (adjustment amount) of interpolated vertex N0 is determined according to the length of vector Cvec. For example, the shift amount of interpolated vertex N0 is a value obtained by multiplying the length of vector Cvec (the distance between center of gravity G of the edge vertex group and centroid vertex C) by interpolation coefficient α. Here, interpolation coefficient α may be a predetermined value. Alternatively, interpolation coefficient α may be determined by the encoding device, and information indicating interpolation coefficient α may be stored in the bitstream. In this case, the decoding device determines interpolation coefficient α based on the information included in the bitstream. For example, the encoding device calculates interpolation coefficient α for each process unit (e.g., a GDU or a slice) such that the shape of the reconstructed point cloud becomes closest to the shape of the original point cloud.

It should be noted that interpolation coefficient α may be 0 < α < 1. Moreover, for example, interpolation coefficient α may be 0 < α < 1/8 or 0 < α < 1/4. It should be noted that the range of interpolation coefficient α may be switched according to the size of the node. For example, when the node has a first size, 0 < α < 1/8 may be applied, and when the node has a second size larger than the first size, 0 < α < 1/4 may be applied. In other words, when the size of the node is large, a wider range may be used. That is, when the size of the node is large, the upper limit of the range of interpolation coefficient α may become larger.

It should be noted that when interpolation coefficient α is predetermined, interpolation coefficient α is set in advance to a value within the range. Accordingly, when the node has the first size, interpolation coefficient α may be set to a first value, and when the node has the second size larger than the first size, interpolation coefficient α may be set to a second value larger than the first value. Moreover, when the encoding device sets interpolation coefficient α, interpolation coefficient α may be set to a value within the range.

Next, the adjustment process for interpolated vertex N1 will be described. Here, interpolated vertex N1 is a case that corresponds to the above first condition. In other words, interpolated vertex N1 is present on the boundary face between a target node and an adjacent node.

In this case, the decoding device makes the positions of the interpolated vertices coincide between the adjacent nodes. When the positions of the interpolated vertices do not coincide between the adjacent nodes, a gap occurs in the reconstructed surface formed by a group of triangles, and this becomes a gap in the reconstructed point cloud as it is. This reduces the accuracy of the reconstructed point cloud. On the other hand, by making the positions of the interpolated vertices coincide between the adjacent nodes, a continuous reconstructed surface can be generated between the nodes.

First, the decoding device determines whether the interpolated vertex is on a node boundary. It should be noted that an interpolated vertex between an edge vertex and a face vertex is present on the node boundary. Accordingly, the decoding device may determine whether the interpolated vertex is a vertex between an edge vertex and a face vertex.

When the interpolated vertex is on the node boundary, the decoding device uses a common value as a shift amount of the interpolated vertex between nodes sharing the interpolated vertex. For example, the common value may be calculated using the average of Cvec of the target node and Cvec of the adjacent node. Alternatively, the common value may be calculated using either Cvec of the target node or Cvec of the adjacent node. For example, the common value may be calculated using Cvec of the preceding node in decoding order (or encoding order) between the target node and the adjacent node.

Alternatively, the decoding device need not adjust the position of the interpolated vertex located on the node boundary. Alternatively, the encoding device may determine whether to adjust the position of the interpolated vertex located on the node boundary, and may store a flag indicating whether to adjust the position of the interpolated vertex located on the node boundary in the bitstream. In this case, according to the flag, the decoding device determines whether to adjust the position of the interpolated vertex located on the node boundary.

Next, the adjustment process for interpolated vertex N2 will be described. Here, interpolated vertex N2 is a case that corresponds to the above second condition. In other words, the pair of two vertices at both ends of the edge on which interpolated vertex N2 is generated is a pair of centroid vertex C and face vertex F.

Here, the face vertex represents the ridge line of the original point cloud defined by two centroid vertices of two nodes. Accordingly, for interpolated vertex N2 which is the middle point between centroid vertex C and face vertex F, the shape of the original point cloud may be better reproduced by not performing the position adjustment. Accordingly, the decoding device does not perform the position adjustment on interpolated vertex N2.

It should be noted that the above process is applied to first triangles other than first triangle C-F-E0 (first triangle C-F-E1 illustrated in FIG. 15 and the other first triangles (not illustrated)). In this manner, a high-definition triangle group (reconstructed surface) is generated.

Moreover, the decoding device reconstructs the point cloud by generating a plurality of points on these second triangles using RayTracing.

### Processing flow

FIG. 16 is a flowchart of a decoding process performed by the decoding device. First, the decoding device arithmetically decodes (entropy-decodes) octree information indicating a trimmed octree from the bitstream, generates the trimmed octree using the octree information, and generates a plurality of leaf-nodes (a leaf-node group) (S101).

Next, the decoding device arithmetically decodes vertex information indicating positions of edge vertices and centroid vertices from the bitstream (S102).

Next, the decoding device arithmetically decodes face vertex information indicating whether to connect centroid vertices of nodes on opposite sides of a face to generate a face vertex (S103). Next, the decoding device generates face vertices based on the face vertex information (S104).

Next, the decoding device reconstructs the point cloud by generating triangles using each vertex and generating a plurality of points on the triangles (S105).

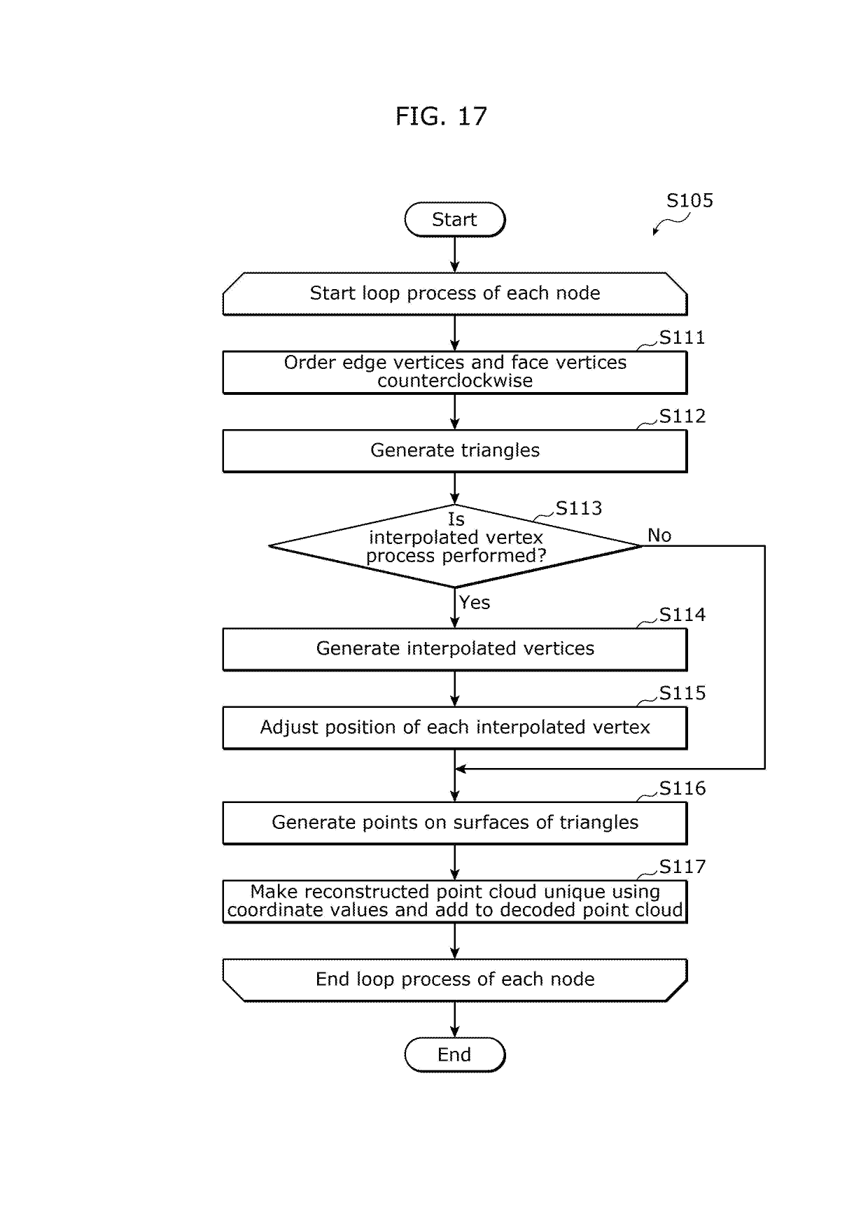

FIG. 17 is a flowchart of a generation process for triangles and points (S105). The decoding device performs the following process of step S111 to step S117 (a loop process) for each of the plurality of leaf-nodes of the trimmed octree. First, the decoding device orders edge vertices and face vertices in the node counterclockwise (S111). Next, the decoding device generates triangles by connecting a vertex group (edge vertices, a centroid vertex, and face vertices) in the node (S112).

Next, the decoding device determines whether to perform the interpolated vertex process (S113). For example, the decoding device obtains (decodes) an interpolated-vertex enable flag from the bitstream, and determines whether to perform the interpolated vertex process according to the obtained interpolated-vertex enable flag.

When performing the interpolated vertex process (Yes in S113), the decoding device generates an interpolated vertex on each of the edges of each triangle (S114). Next, the decoding device adjusts the position of each interpolated vertex (S115). In this manner, four triangles obtained by subdividing the original triangle are generated.

Next, the decoding device generates a plurality of points on surfaces of the triangles (four triangles obtained by subdivision) (S116). Next, the decoding device makes the reconstructed point cloud unique in the node using coordinate values and adds to the decoded point cloud (S117). Here, making it unique means excluding a point whose coordinate value is duplicated. The loop process for the target node is thus completed.

On the other hand, when not performing the interpolated vertex process (No in S113), the decoding device skips step S114 and step S115 and generates a plurality of points on surfaces of the triangles (S116). Next, the decoding device makes the reconstructed point cloud in the node unique using coordinate values and adds to the decoded point cloud (S117).

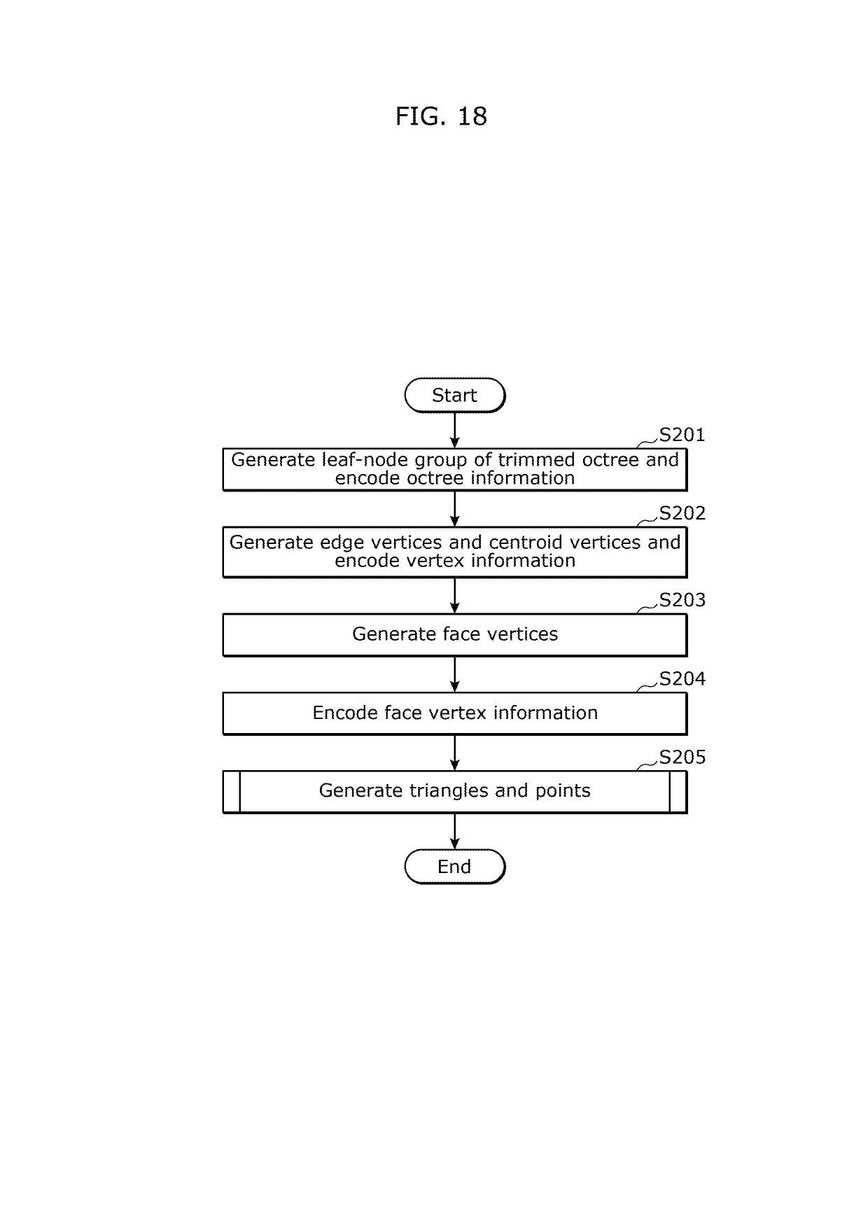

FIG. 18 is a flowchart of an encoding process performed by the encoding device. First, the encoding device generates a trimmed octree by octree-dividing the point cloud, and generates a plurality of leaf-nodes (a leaf-node group) of the trimmed octree. The encoding device also arithmetically encodes (entropy-encodes) octree information indicating the trimmed octree, and stores the encoded octree information in the bitstream (S201).

Next, for each of the nodes (leaf-nodes), the encoding device generates edge vertices and centroid vertices from the distribution of the point cloud in the node, arithmetically encodes (entropy-encodes) vertex information indicating position information of each of the vertices, and stores the encoded vertex information in the bitstream (S202).

Next, the encoding device generates a face vertex at a position where a line segment connecting the centroid vertex of the target node and the centroid vertex of the adjacent node intersects with the face between the nodes (S203).

Next, the encoding device encodes the face vertex information and stores the encoded face vertex information in the bitstream (S204).

Next, the encoding device reconstructs the point cloud by generating triangles using each vertex and generating a plurality of points on the triangles (S205). It should be noted that the details of step S205 are similar to those of step S105 in the decoding device. It should be noted that the encoding device determines whether to perform the interpolated vertex process in step S113 and stores the interpolated-vertex enable flag indicating the determination result in the bitstream. Moreover, the point cloud reconstructed by the encoding device is used for the subsequent encoding process (e.g., a prediction process).

### Syntax

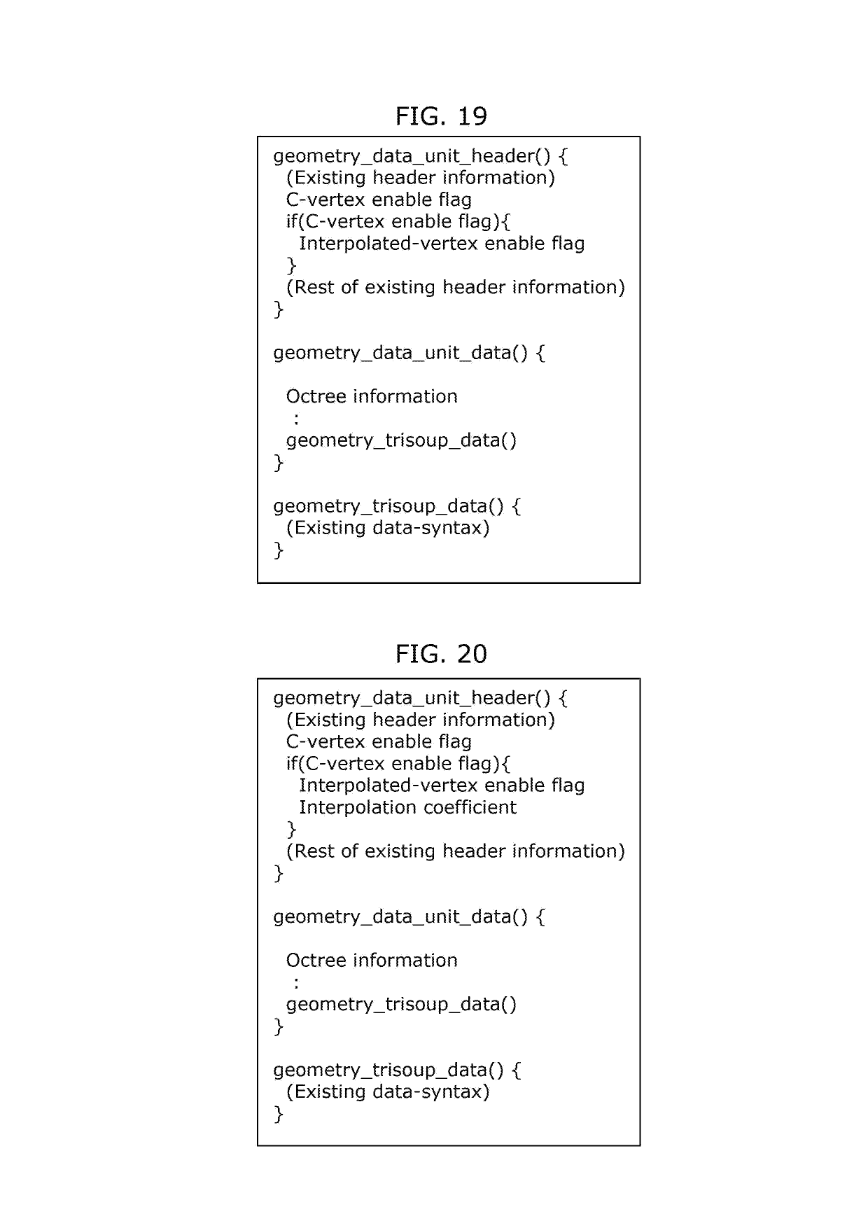

The syntax of information transmitted from the encoding device to the decoding device for the interpolated vertex process according to the present embodiment will be described. FIG. 19 is a diagram illustrating a syntax example of geometry_data_unit_header (GDUH) and geometry_data_unit_data (GDU).

As illustrated in FIG. 19, the GDUH includes a C-vertex enable flag and an interpolated-vertex enable flag in addition to existing header information. The C-vertex enable flag indicates whether the function of generating centroid vertices is enabled (whether to generate centroid vertices). When the function of generating centroid vertices is enabled, the decoding device generates centroid vertices and generates triangles using the centroid vertices in addition to the edge vertices. On the other hand, when the function of generating centroid vertices is not enabled, the decoding device does not generate centroid vertices and generates triangles using only the edge vertices.

The interpolated-vertex enable flag is 1-bit information indicating whether to perform the above-mentioned interpolated vertex process (generation and adjustment of interpolated vertices). For example, this interpolated-vertex enable flag is included in the GDUH when the function of generating centroid vertices is enabled (when the C-vertex enable flag is ON (e.g., 1)), and is not included in the GDUH (not included in the bitstream) when the function of generating centroid vertices is not enabled (when the C-vertex enable flag is OFF (e.g., 0)).

The GDU includes octree information and geometry_trisoup_data. The octree information is information indicating the structure of the trimmed octree, and is information indicating positions of a plurality of leaf-nodes included in the trimmed octree.

Geometry_trisoup_data includes information related to generation of triangles. For example, geometry_trisoup_data includes vertex information on edge vertices and centroid vertices, and face vertex information on face vertices.

FIG. 20 is a diagram illustrating another syntax example of GDUH and GDU. In FIG. 20, the GDUH includes an interpolation coefficient in addition to the information illustrated in FIG. 19. The interpolation coefficient is used to calculate a shift amount for use in adjustment of the position of the interpolated vertex. For example, the interpolation coefficient is a coefficient to be multiplied by the length of vector Cvec.

For example, this interpolation coefficient is included in the GDUH when the function of generating centroid vertices is enabled, and is not included in the GDUH (not included in the bitstream) when the function of generating centroid vertices is not enabled.

It should be noted that although an example has been described here in which the interpolated-vertex enable flag and the interpolation coefficient are included in the GDUH when the C-vertex enable flag is ON, at least one of the interpolated-vertex enable flag or the interpolation coefficient may be included in the GDUH regardless of the value of the C-vertex enable flag.

Moreover, at least one of the interpolated-vertex enable flag or the interpolation coefficient may be included in control information other than the GDUH included in the bitstream. For example, at least one of the interpolated-vertex enable flag or the interpolation coefficient may be included in the control information (header) on a sequence basis. It should be noted that a sequence is a unit including a plurality of frames. The control information on a sequence basis is, for example, a sequence parameter set (SPS) or a geometry parameter set (GPS). SPS is control information (a parameter set) common to the plurality of frames. GPS is metadata (a parameter set) related to encoding of position information, and is metadata common to the plurality of frames.

### Variations

Although an example of adjusting the position of the interpolated vertex has been described above, in addition to the interpolated vertex, the position of at least one of the centroid vertex, the edge vertex, or the face vertex may be adjusted. In this manner, the accuracy of the reconstructed point cloud can be improved.

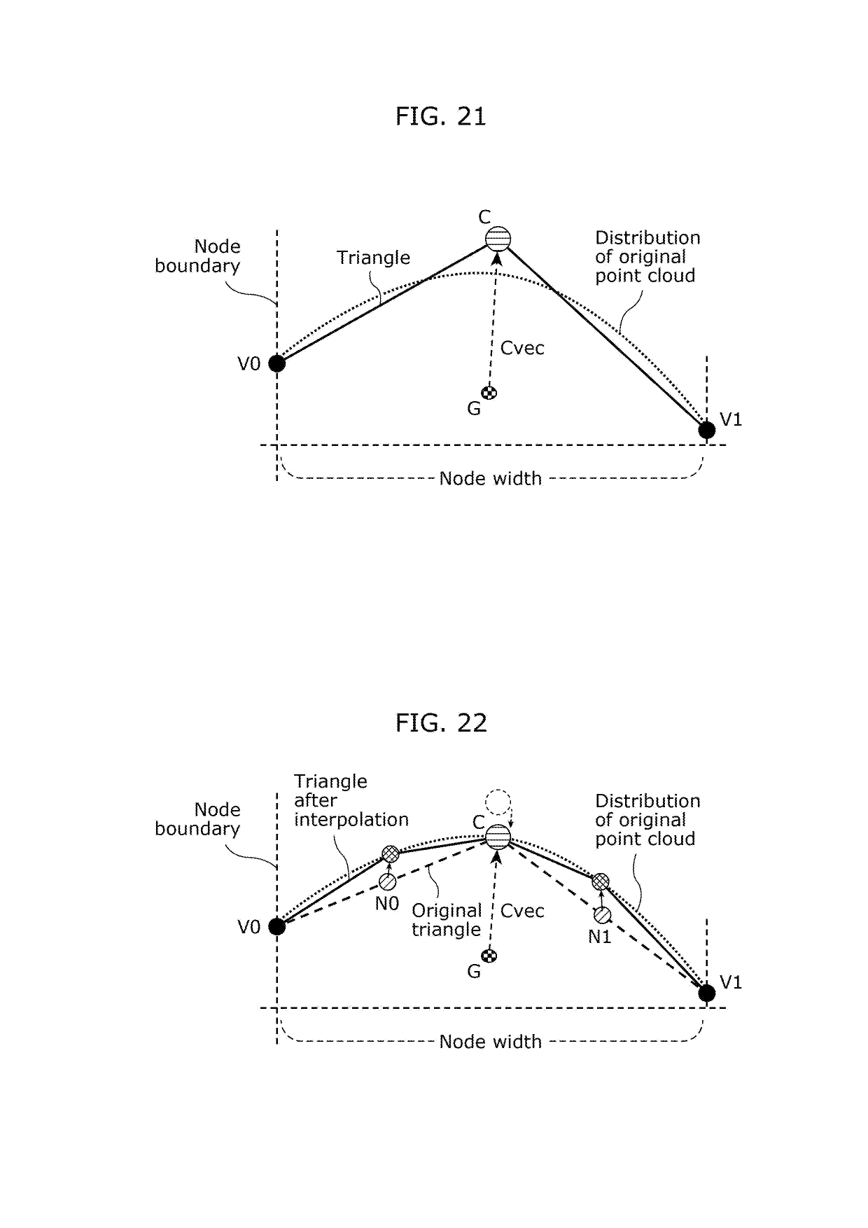

FIG. 21 is a diagram illustrating an example of various vertices and an example of triangles. The example illustrated in FIG. 21 differs from the example illustrated in FIG. 13 in the position of centroid vertex C.

Specifically, in the TriSoup scheme, it is necessary to represent a shape approximating the shape of the original point cloud using a small number of vertex types and a small number of vertices. Accordingly, for example, as illustrated in FIG. 21, in some cases, the position of centroid vertex C is placed slightly outside the distribution of the original point cloud.

For example, the encoding device performs, on the length of vector Cvec, integer rounding in which rounding up of the fractional part is prioritized. For example, rounding up is performed when the fractional part is 0.3 or more. In this case, the protrusion amount (shift amount from the original position) of centroid vertex C is in the range of -0.3 to +0.7.

On the other hand, when the interpolated vertex process described in the present embodiment is used, such a process for adjusting the position of the centroid vertex is not necessary since the number of vertices increases. Accordingly, when the interpolated vertex process is applied, the decoding device readjusts the position of centroid vertex C. FIG. 22 is a diagram illustrating an example of various vertices and an example of triangles when this adjustment process is performed.

For example, the decoding device adjusts vector Cvec to be shorter so that the vertex group more accurately represents the shape of the original point cloud. For example, the decoding device calculates an adjustment amount by multiplying the length of vector Cvec by a predetermined coefficient. For example, this coefficient may be 1/4 or 1/8. The decoding device adjusts vector Cvec by subtracting the calculated adjustment amount from the length of vector Cvec. In other words, the position of centroid vertex C is shifted in the direction opposite to the direction of vector Cvec by the adjustment amount.

Moreover, in the above-mentioned interpolated vertex process, the shift amount of the interpolated vertex is calculated using vector Cvec that has been adjusted in this manner.

The decoding device may switch whether to perform the above-mentioned interpolated vertex process according to the length of vector Cvec. For example, the decoding device determines whether the length of vector Cvec is greater than a first threshold. When the length of vector Cvec is greater than the first threshold, the decoding device determines that the bulge of the point cloud shape is large and uses the interpolated vertex process. On the other hand, when the length of vector Cvec is less than or equal to the first threshold, the decoding device determines that the bulge of the point cloud shape is small and does not use the interpolated vertex process.

For example, the first threshold may be a predetermined fixed value. Alternatively, the encoding device may determine the value of the first threshold and store information indicating the value of the first threshold in metadata such as the GDUH. In this case, the decoding device determines the value of the first threshold based on the information.

Moreover, the decoding device may switch whether to perform the interpolated vertex process according to the size of the node. For example, the decoding device determines whether the size of the target node is greater than a second threshold. When the size of the target node is greater than the second threshold, the decoding device applies the interpolated vertex process to the target node. On the other hand, when the size of the target node is less than or equal to the second threshold, the decoding device does not apply the interpolated vertex process to the target node.

For example, the second threshold may be a predetermined fixed value. Alternatively, the encoding device may determine the value of the second threshold and store information indicating the value of the second threshold in metadata such as the GDUH. In this case, the decoding device determines the value of the second threshold based on the information.

It should be noted that the decoding device may apply the interpolated vertex process regardless of the length of vector Cvec, or may apply the interpolated vertex process regardless of the size of the node.

Moreover, in the above description, an example has been described in which one interpolated vertex is generated on one edge of the original triangle, but two or more interpolated vertices may be generated on one edge. It should be noted that two or more interpolated vertices may be generated on each of all edges of the original triangle, or two or more interpolated vertices may be generated on some edges of the original triangle and one interpolated vertex may be generated on the other edges.

Also in this case, the adjustment process for the interpolated vertex may be performed in a similar manner to the above. In other words, all the interpolated vertices on a given edge are shifted in the direction of vector Cvec. This can make the shape of the reconstructed point cloud closer to the original point cloud, and thus can improve the accuracy of the reconstructed point cloud.

Moreover, in the above description, the shift direction of the interpolated vertex is the direction from center of gravity G of the edge vertex group toward centroid vertex C (the direction of vector Cvec), but any other direction is possible. For example, the shift direction of the interpolated vertex may be a direction intersecting the original triangle. For example, the shift direction of the interpolated vertex may be a direction in which the position of the interpolated vertex moves away from center of gravity G of the edge vertex group. For example, the shift direction of the interpolated vertex may be the direction of the normal to the triangle. Specifically, the shift direction of the interpolated vertex may be a direction along the normal to the triangle and a direction in which the position of the interpolated vertex moves away from center of gravity G of the edge vertex group. Alternatively, the shift direction of the interpolated vertex may be an outward direction of the node or a direction in which the position of the interpolated vertex moves away from the center of the node.

Moreover, at least one of the method of adjusting the interpolated vertex, the vector for use in adjustment, the adjustment direction (shift direction), the adjustment amount (shift amount), or the interpolation coefficient may be shared among all the interpolated vertices included in a processing unit, or may be different for each of the interpolated vertices. Here, the processing unit may be a node, or may be a unit including a plurality of nodes (e.g., a GDU or a slice).

### Summary

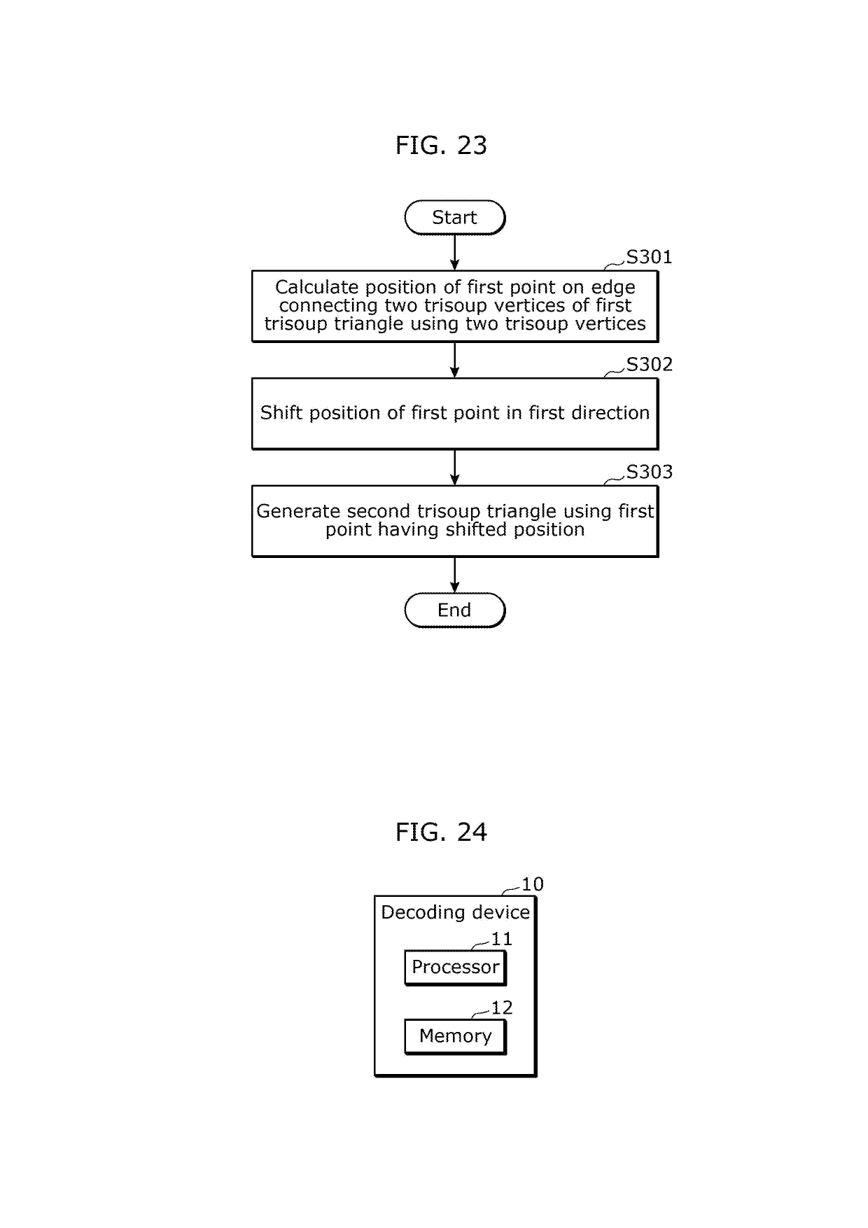

As described above, the decoding device (three-dimensional data decoding device) according to the embodiment performs the process illustrated in FIG. 23. The decoding device decodes three-dimensional points. The decoding device: calculates a position of a first point (e.g., an interpolated vertex) on an edge connecting two TriSoup vertices (e.g., a centroid vertex, an edge vertex, or a face vertex) of a first TriSoup triangle using the two TriSoup vertices (S301); shifts the position of the first point in a first direction (S302); and generates a second TriSoup triangle using the first point having the position shifted (S303). The first TriSoup triangle is used to generate a plurality of three-dimensional points in a node according to a TriSoup scheme. The node is a unit in an octree structure including the plurality of three-dimensional points.

With this, the decoding device generates the first point on the edge of the first TriSoup triangle in addition to the TriSoup vertices, and generates the second TriSoup triangle using the first point. Accordingly, it is possible to improve the accuracy of the reconstructed three-dimensional data. Furthermore, the decoding device may be able to further improve the accuracy of the three-dimensional data by shifting the position of the first point. Here, the accuracy is an index indicating how much the shape of the original point cloud has been reconstructed, and a higher value indicates better reconstruction of the original point cloud. In other words, a finer representation can be achieved by generating the second TriSoup triangle using the added first point as described in the decoding device, thus improving the accuracy.

For example, the first direction is a direction in which the position of the first point moves away from a center of gravity (e.g., center of gravity G) of a plurality of edge vertices of the node. With this, the decoding device can accurately reconstruct the shape of the original point cloud that is convex in the direction away from the center of gravity of the plurality of edge vertices.

For example, the first direction is a direction from the center of gravity of the plurality of edge vertices of the node toward the centroid vertex of the node (e.g., the direction of vector Cvec). With this, the decoding device can improve the reconstruction accuracy around the centroid vertex.

For example, the first direction is the direction in which the position of the first point moves away from the center of gravity of the plurality of edge vertices of the node, and is also a direction along a normal of the first TriSoup triangle. With this, the decoding device can reconstruct three-dimensional data to be closer to the shape of the original three-dimensional data.

For example, a shift amount applied in the shifting of the position of the first point becomes greater as a distance between the center of gravity of the plurality of edge vertices and the centroid vertex of the node becomes greater. With this, the decoding device can reconstruct three-dimensional data to be closer to the shape of the original three-dimensional data.

For example, a shift amount applied in the shifting of the position of the first point is calculated by multiplying a distance between the center of gravity of the plurality of edge vertices and the centroid vertex of the node by a coefficient (e.g., an interpolation coefficient), and the coefficient is greater than 0 and less than 1/8. When the coefficient is too large, an error in which the corrected position is outside the node is prone to occur. In this regard, by using a coefficient less than 1/8, it is possible to reduce the occurrence of such an error.

For example, when a size of the node is greater than a threshold, the calculating of the position of the first point, the shifting of the position of the first point, and the generating of the second TriSoup triangle are performed, and when the size of the node is less than the threshold, the calculating of the position of the first point, the shifting of the position of the first point, and the generating of the second TriSoup triangle are not performed. When the size of the node is large, the accuracy of the reconstructed three-dimensional data is likely to be low. In such a case, by calculating the position of the first point, shifting the position of the first point, and generating the second TriSoup triangle, it is possible to efficiently improve the accuracy of the three-dimensional data.

For example, the first point is a middle point of the edge. With this, the decoding device can efficiently improve the accuracy of the three-dimensional data by generating the first point at the position of the middle point of the edge.

For example, the two TriSoup vertices include a face vertex generated on a face of the node excluding edges of the node. With this, the decoding device can improve the accuracy of the reconstructed three-dimensional data by using the face vertex.

For example, each of three TriSoup vertices of the first TriSoup triangle is any one of an edge vertex, a centroid vertex, and a face vertex provided on a face of the node excluding edges of the node, when a pair of the two TriSoup vertices is not a pair of the face vertex and the centroid vertex, the shifting of the position of the first point is performed, and when the pair of the two TriSoup vertices is the pair of the face vertex and the centroid vertex, the shifting of the position of the first point is not performed.

When the pair of the two TriSoup vertices is composed of the face vertex and the centroid vertex, the shape of the reconstructed three-dimensional data may deviate from the shape of the original three-dimensional data by shifting the position of the first point. Accordingly, in such a case, by not shifting, it is possible to improve the accuracy of the reconstructed three-dimensional data.

FIG. 24 is a block diagram of decoding device 10. For example, decoding device 10 includes processor 11 and memory 12, and processor 11 performs the above process using memory 12.

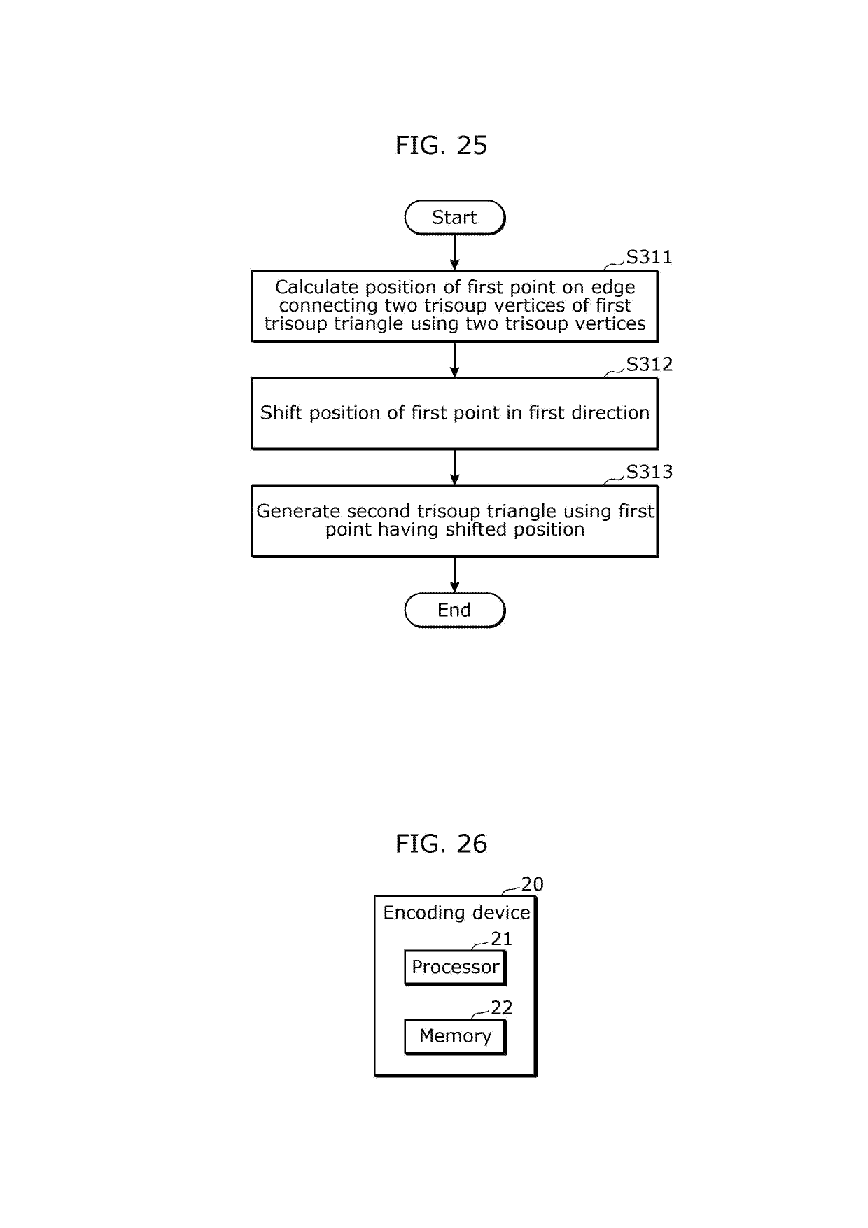

The encoding device (three-dimensional data encoding device) according to the embodiment performs the process illustrated in FIG. 25. The encoding device encodes three-dimensional points. The encoding device: calculates a position of a first point (e.g., an interpolated vertex) on an edge connecting two TriSoup vertices (e.g., a centroid vertex, an edge vertex, or a face vertex) of a first TriSoup triangle using the two TriSoup vertices (S311); shifts the position of the first point in a first direction (S312); and generates a second TriSoup triangle using the first point having the position shifted (S313). The first TriSoup triangle is used to generate a plurality of three-dimensional points in a node according to a TriSoup scheme. The node is a unit in an octree structure including the plurality of three-dimensional points.

With this, the encoding device generates the first point on the edge of the first TriSoup triangle in addition to the TriSoup vertices, and generates the second TriSoup triangle using the first point. Accordingly, it is possible to improve the accuracy of the reconstructed three-dimensional data. Furthermore, the encoding device may be able to further improve the accuracy of the three-dimensional data by shifting the position of the first point.

FIG. 26 is a block diagram of encoding device 20. For example, encoding device 20 includes processor 21 and memory 22, and processor 21 performs the above process using memory 22. It should be noted that the encoding device may perform the same process as the above-described decoding device.

An encoding device (three-dimensional data encoding device), a decoding device (three-dimensional data decoding device), and the like, according to embodiments of the present disclosure and variations thereof have been described above, but the present disclosure is not limited to these embodiments, etc.

It should be noted that each of the processors included in the encoding device, the decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as an encoding method (three-dimensional data encoding method), a decoding method (three-dimensional data decoding method), or the like executed by the encoding device (three-dimensional data encoding device), the decoding device (three-dimensional data decoding device), and the like.

Furthermore, the present disclosure may be implemented as a program for causing a computer, a processor, or a device to execute the above-described encoding method or decoding method. Furthermore, the present disclosure may be implemented as a bitstream generated by the above-described encoding method. Furthermore, the present disclosure as a recording medium on which the program or the bitstream is recorded. For example, the present disclosure may be implemented as a non-transitory computer-readable recording medium on which the program or the bitstream is recorded.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

An encoding device, a decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to an encoding device and a decoding device.

1. A decoding method of decoding three-dimensional points, the decoding method comprising: calculating a position of a first point on an edge connecting two Triangle-Soup (TriSoup) vertices of a first TriSoup triangle using the two TriSoup vertices; shifting the position of the first point in a first direction; and generating a second TriSoup triangle using the first point having the position shifted, wherein the first TriSoup triangle is used to generate a plurality of three-dimensional points in a node according to a TriSoup scheme, and the node is a unit in an octree structure including the plurality of three-dimensional points.

2. The decoding method according to claim 1, wherein the first direction is a direction in which the position of the first point moves away from a center of gravity of a plurality of edge vertices of the node.

3. The decoding method according to claim 1, wherein the first direction is a direction from a center of gravity of a plurality of edge vertices of the node toward a centroid vertex of the node.

4. The decoding method according to claim 2, wherein the first direction is the direction in which the position of the first point moves away from the center of gravity of the plurality of edge vertices of the node and is also a direction along a normal of the first TriSoup triangle.

5. The decoding method according to claim 3, wherein a shift amount applied in the shifting of the position of the first point becomes greater as a distance between the center of gravity of the plurality of edge vertices and the centroid vertex of the node becomes greater.

6. The decoding method according to claim 3, wherein a shift amount applied in the shifting of the position of the first point is calculated by multiplying a distance between the center of gravity of the plurality of edge vertices and the centroid vertex of the node by a coefficient, and the coefficient is greater than 0 and less than 1/8.

7. The decoding method according to claim 1, wherein when a size of the node is greater than a threshold, the calculating of the position of the first point, the shifting of the position of the first point, and the generating of the second TriSoup triangle are performed, and when the size of the node is less than the threshold, the calculating of the position of the first point, the shifting of the position of the first point, and the generating of the second TriSoup triangle are not performed.

8. The decoding method according to claim 1, wherein the first point is a middle point of the edge.

9. The decoding method according to claim 1, wherein the two TriSoup vertices include a face vertex generated on a face of the node excluding edges of the node.

10. The decoding method according to claim 1, wherein each of three TriSoup vertices of the first TriSoup triangle is any one of an edge vertex, a centroid vertex, and a face vertex provided on a face of the node excluding edges of the node, when a pair of the two TriSoup vertices is not a pair of the face vertex and the centroid vertex, the shifting of the position of the first point is performed, and when the pair of the two TriSoup vertices is the pair of the face vertex and the centroid vertex, the shifting of the position of the first point is not performed.

11. An encoding method of encoding three-dimensional points, the encoding method comprising: calculating a position of a first point on an edge connecting two TriSoup vertices of a first TriSoup triangle using the two TriSoup vertices; shifting the position of the first point in a first direction; and generating a second TriSoup triangle using the first point having the position shifted, wherein the first TriSoup triangle is used to generate a plurality of three-dimensional points in a node according to a TriSoup scheme, and the node is a unit in an octree structure including the plurality of three-dimensional points.

12. A decoding device that decodes three-dimensional points, the decoding device comprising: a processor; and memory, wherein using the memory, the processor: calculates a position of a first point on an edge connecting two TriSoup vertices of a first TriSoup triangle using the two TriSoup vertices; shifts the position of the first point in a first direction; and generates a second TriSoup triangle using the first point having the position shifted, wherein the first TriSoup triangle is used to generate a plurality of three-dimensional points in a node according to a TriSoup scheme, and the node is a unit in an octree structure including the plurality of three-dimensional points.
